(19) United States
(12) Patent Application Publication
(10) Pub. No.: US 2006/0226257 A1
(43) Pub. Date: Oct. 12, 2006

(54) Self-rotating spherical sprinkler

(76) Inventor: Luca Lee, Tu-Cheng City (TW)

Correspondence Address: TROXELL LAW OFFICE PLLC, SUITE 1404, 5205 LEESBURG PIKE, FALLS CHURCH, VA, 22041, US

(21) Appl. No.: 11/099,559

(22) Filed: Apr. 6, 2005

(51) Int. Cl. B05B 17/08; B05B 3/06

(52) U.S. Cl. 239/251; 239/17

(57) ABSTRACT

A dynamic sprinkling device adopts a deflecting water pressure to facilitate self-rotation of a sprinkling sphere, and allows the water outlets thereon to burst out a variety of spraying points with different rotating patterns through the rotation of the sphere. The self-rotating spherical sprinkler can be installed on any type of water outlets. The structure of the self-rotating spherical sprinkler is an accommodation of a hollow cylinder and a sphere. Through a deflecting through hole on the side of the hollow cylinder, water is injected into the hollow sphere and pushes the sphere to rotate. Water is also allowed to burst out from the water outlets having a variety of arrangements on the sphere.

### FIELD OF THE INVENTION

The present invention relates to a sprinkler; in particular, it is related to a self-rotating spherical sprinkler.

### BACKGROUND OF THE INVENTION

Most spraying or sprinkling devices, such as a shower nozzle, a sprinkler used for gardening, a fire sprinkler for fire extinguishing, a professional sprayer or sprinkler, or a fountain sprinkler, have two major drawbacks. To name one, if the sprayer or sprinkler has a simple structure, it has either a fixed sprayer or sprinkler head, and cannot provide complete and overall spraying or sprinkling with multiple dropping points. Another type is a rotary dynamic sprayer or sprinkler. However, it has a complex structure and high manufacturing cost, and it is also easy to break and hard to maintain.

Due to the drawbacks on the conventional products, the inventor invents a self-rotating spherical sprinkler having a simple structure, a great performance, and no need for maintenance. The spherical sprinkler of the present invention can be installed on a variety of water outlets on the water pipe. The structure is designed to have the spherical sprinkler connect to a variety of water outlets. The spherical sprinkler is designed with a hollow cylinder therein. The outside of the hollow cylinder is inserted with a hollow sphere. Water can be injected into the hollow sphere through a deflecting through hole on the hollow cylinder, causing the sphere to rotate. Water is also allowed to spray out from the water outlets with a variety of arrangements. The water spraying out can have a dynamic spray with different spraying points as the sphere rotates.

### SUMMARY OF THE INVENTION

A self-rotating spherical sprinkler to install on a variety of water outlet arrangements is provided. The present invention is characterized in that a hollow cylinder corresponds to a sphere. Water is injected into the hollow sphere through a deflecting through hole on one side of the hollow cylinder, causing the sphere to rotate. Water bursts out from the water outlets on the sphere with a variety of arrangements. The water spray can also be a dynamic water spray having different spraying spots as the sphere rotates.

### DESCRIPTION OF THE DRAWINGS

FIG. 1 is a 3D exploded view of the present invention;

FIG. 2 is a cross-sectional view of the present invention;

FIG. 3 is a cross-sectional view of the assembly of the present invention;

FIG. 4 is a 3D view of another embodiment of the present invention;

FIG. 5 is a 3D view of yet another embodiment of the present invention;

FIGS. 6-8 are a front view of small through holes on an upper housing in accordance with the present invention;

FIG. 9 is a 3D view of another embodiment of the present invention;

FIG. 10 is a cross-sectional view of the assembly of another embodiment of the present invention;

FIG. 11 is a cross-sectional view of the assembly of another embodiment of the present invention.

### DESCRIPTION OF THE EMBODIMENTS

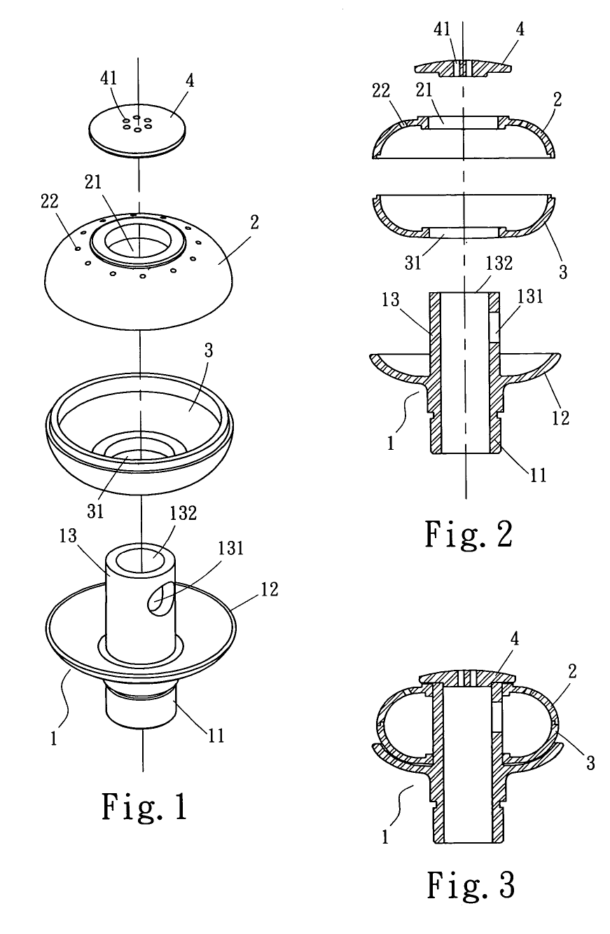

Refer to FIGS. 1 and 2. The self-rotating spherical sprinkler of the present invention includes a base 1, an upper housing 2, a lower housing 3, and an end board 4.

The lower end of the base 1 is connected to a hollow connecting portion 11 connecting to the water outlet end of a variety of water pipes. The top of the hollow connecting portion 11 is provided with a circular blocking board 12. The top of the circular blocking board 12 is a hollow cylinder 13. At an appropriate location on the side of the hollow cylinder 13 is opened with a deflecting through hole 131. The lower end of the hollow cylinder 13 is presented as an opening 132.

As shown in FIG. 3, the center of the above-mentioned upper housing 2 and lower housing 3 is respectively provided with a through hole 21, 31 corresponding to the hollow cylinder. The upper housing 2 and the lower housing 3 can form into a hollow sphere. By inserting the hollow sphere on the hollow cylinder 13 on base 1 through the through holes 21, 31, the hollow sphere can rotate on the hollow cylinder 13.

After the hollow sphere composed of the upper housing 2 and the lower housing 3 is inserted on the hollow cylinder 13, the opening 132 at the end of the hollow cylinder 13 is closed with the end board 4, such that the hollow sphere is positioned on the hollow cylinder 13 and performs free rotation within the area.

Refer to FIGS. 1, 2, and 3. The upper housing 2 is provided with small through holes 22 in circular arrangement, while the end board 4 is provided with small through holes 41. Thereby, after water enters the hollow cylinder 13 through the hollow connecting portion 11, it enters the hollow portion within the hollow sphere through the deflecting through hole 131 on the side due to water pressure. The water pressure and the pushing force together make the hollow sphere rotate, and allow water spray to be burst out from the circularly-arranged small through holes 22 on the upper housing 2 and the small through holes 41 on the end board 4. In addition, because water spray will come out from the small through holes 21 on the upper housing 2 as the hollow sphere rotates, it allows a continuous rotation and is characterized in the dynamic rotating spray having different spraying locations.

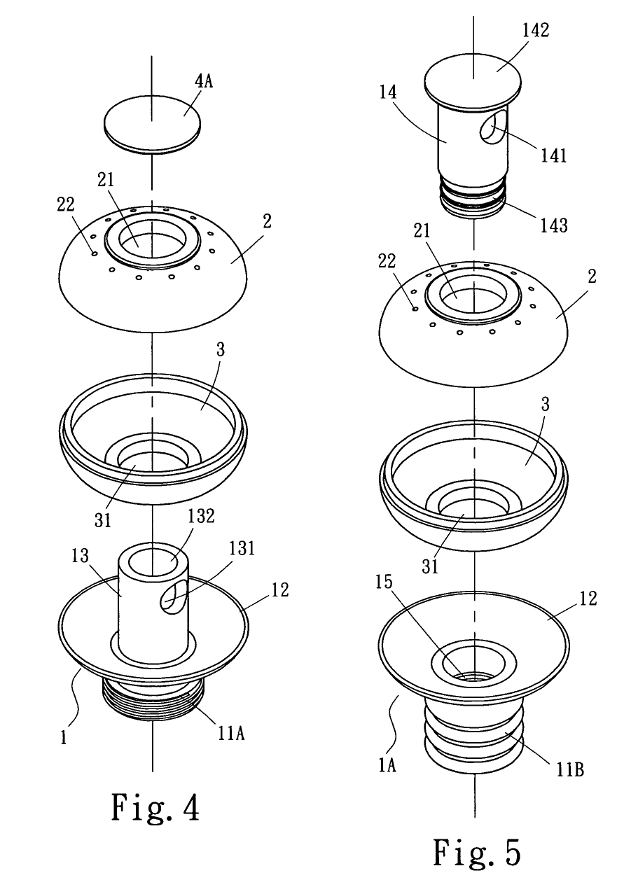

As shown in FIGS. 4 and 5, the outside of the connecting portion 11 on the base 1 can be designed with a screwing thread portion 11A and a protruding thread portion 11B so as to accommodate a variety of water pipe connections.

As shown in FIGS. 4 and 5, the above-mentioned end board 4 can be implemented without small through holes 41, but with a closed end board 4A instead.

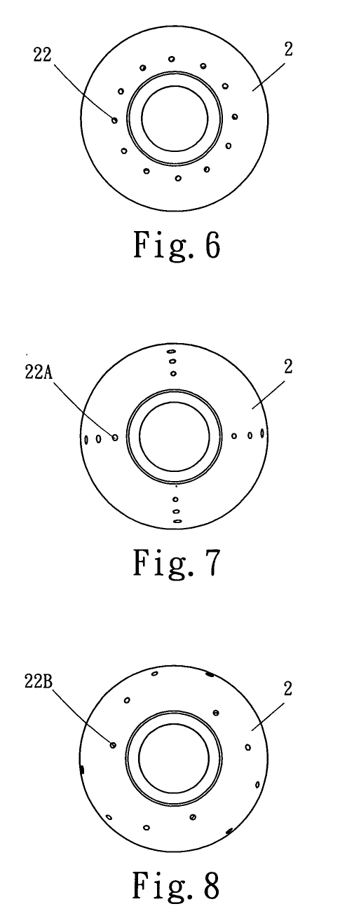

As shown in FIGS. 6 to 8, the design of the circularly arranged small through holes 22 on the above-mentioned upper housing 2 can also be designed as small through holes in a cross shape arrangement 22A or as small through holes in a spiral shape arrangement 22B. Thereby, water spray shooting or bursting out can have a better water dance or massage or uniformed effect.

As shown in FIG. 5, the hollow cylinder 13 integrally formed with the base 1 can also be implemented as a separate hollow cylinder 14 by integrally forming the hollow cylinder 13 and the end board 4. The separate hollow cylinder 13 has the same deflecting through hole 141 and blocking flange board 142 on the top, and a screwing thread portion 143 on the bottom. The screwing thread portion 143 can be screwed into the thread of the screw 15 on the base without the hollow cylinder 1A, having the same effect.

In the present invention, the circularly arranged small through holes 22, the small through holes in a cross shape arrangement 22A, and the spirally arranged small through holes 22B, as well as the small through holes 41 on the end board 4 designed on the above mentioned upper housing 2 are penetrating at an appropriate angle or direction such that water spray coming out has a predetermined direction.

Refer to FIG. 9. The implementation of the deflecting through hole 131 at the appropriate location on the side of the hollow cylinder 13 integrally formed with the base 1 can be designed with 2 or 4 deflecting through holes 131A.

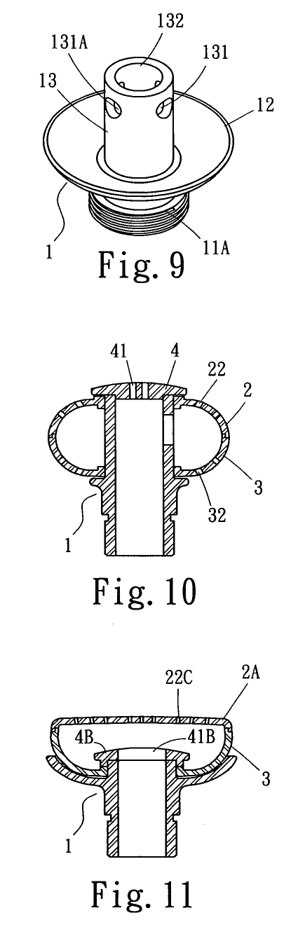

Refer to FIG. 10. Wherein the lower housing 3 can be provided with the same circularly arranged small through holes 32 as those on the upper housing 2.

Refer to FIG. 11. Wherein the upper housing 2 can be replaced with an arc shaped housing 2A. The arc shaped housing 2A is provided with small through holes 22C in a circular arrangement thereon, while the center of the end board 4B is provided with big through holes 41B to be used as a shower nozzle.

What is claimed is:

1. A self-rotating spherical sprinkler, comprising a base 1, an upper housing 2, a lower housing 3, and an end board 4;
the lower end of said base 1 connecting to a hollow connecting portion 11 of a water outlet of a water pipe, the top of said hollow connecting portion 11 provided with a circular blocking board 12, the top of said circular blocking board 12 being a hollow cylinder 13, at an appropriate location on the side of said hollow cylinder 13 being a deflecting through hole 131, the end of said hollow cylinder 13 being an opening 132;
an upper housing 2 and a lower housing 3 correspondingly assembled into a hollow sphere, the center thereof respectively provided with a through hole 21, 31 corresponding to said hollow cylinder, said upper housing 2 provided with a small through hole 21, after assembled into the hollow sphere, said hollow sphere capable of being inserted on said hollow cylinder 13 of said base 1 through said through holes 21, 31 so as to allow said sphere to rotate on said hollow cylinder 13;
an end board 4 provided small through holes 41 thereon, after said hollow sphere is inserted on said hollow cylinder 13, said opening 132 on the end of said hollow cylinder 13 being closed;
wherein said self-rotating spherical sprinkler is characterized in that after water comes into said hollow cylinder 13 through said hollowing connecting portion 11, water will go into the hollow portion of said hollow sphere through said deflecting through hole 131 due to water pressure, as well as rotate said hollow sphere, such that water spray bursts out from said through holes 21 of said upper housing 2 and said small through holes 41 of said end board 4, and because water spray bursts out from said small through holes 21 of said upper housing 2 when said hollow sphere rotates, a continuous rotation is formed and different spraying locations of a dynamic water spray are provided.

2. The self-rotating spherical sprinkler of claim 1, wherein the outside of said hollow connecting portion 11 of said base 1 can be designed with a screwing thread portion 11A and a protruding thread portion 11B so as to accommodate a variety of water pipes.

3. The self-rotating spherical sprinkler of claim 1, wherein said end board 4 can also be provided without said small through holes 41, but be a closed end board 4A.

4. The self-rotating spherical sprinkler of claim 1, wherein said small through holes arranged circularly 21 on said upper housing 2 can also be small through holes arranged in cross shape 21A or be small through holes arranged in spiral shape 21B.

5. The self-rotating spherical sprinkler of claim 1, wherein said small through holes in a circular arrangement 22, said small through holes in a cross shape arrangement 22A, and said small through holes in a spiral shape arrangement 22B designed on said upper housing 2, as well as small through holes 41 on said end board 4 penetrate at an appropriate angle or direction such that water spray has a predetermined direction.

6. The self-rotating spherical sprinkler of claim 1, wherein said hollow cylinder 13 integrally formed on said base 1 can also be a separate hollow cylinder 14 by integrally forming said hollow cylinder 13 and said end board 4, a deflecting through hole 141 and an end flange board 142 are also provided on the top, while the bottom end is provided with a screwing portion 143 for screwing into the thread of a screw 15 on said base without said hollow cylinder 1A with the same effect.

7. The self-rotating spherical sprinkler of claim 1, wherein when implementing said deflecting through hole 131 opened at the appropriate location on the side of said hollow cylinder 13 of said base 1, said deflecting through hole 131 can be designed with two or four deflecting through holes 131A.

8. The self-rotating spherical sprinkler of claim 1, wherein said lower housing 3 can be provided with small through holes 32 in the same circular arrangement as provided on said upper housing 2.

9. The self-rotating spherical sprinkler of claim 1, wherein said upper housing 2 can be replaced with an arc shape housing 2A, having small through holes 22C provided in a circular arrangement thereon, and having a big through hole 41B provided in the center of said end board 4B.
